(19) United States
(12) Patent Application Publication
(10) Pub. No.: US 2012/0102230 A1
(43) Pub. Date: Apr. 26, 2012

(54) NETWORK STORAGE SYSTEM AND NETWORK STORAGE METHOD

(76) Inventors: Shu-Kai Ho, Hsinchu City (TW); Shih-Jen Lu, Taipei County (TW)

(21) Appl. No.: 13/008,875

(22) Filed: Jan. 18, 2011

(30) Foreign Application Priority Data
Oct. 26, 2010 (TW) 099136524

(51) Int. Cl. G06F 15/16

(52) U.S. Cl. 709/246

(57) ABSTRACT

The present invention provides a network storage system for increasing data reading efficiency of a net storage service and a network storage method for increasing data reading efficiency of the net storage service. The network storage system comprises: a network processing module, a first fast file transmitting module, and a second fast file transmitting module. The present invention can omit the standard process of the traditional operation system processing files when reading data, and the network storage system and the network storage method of the present invention can use a new file processing procedure in the second fast file transmitting module. In this way, the present invention can shorten the file processing flow in the traditional network storage system, so as to increase data reading efficiency of the net storage service over 250%.

### BACKGROUND OF THE INVENTION

1. Field of the Invention

The present invention relates to a method for providing a network storage architecture, and more particularly, to a network storage system for increasing data reading efficiency of a net storage service and a network storage method for increasing data reading efficiency of the net storage service.

2. Description of the Prior Art

A network-attached storage (NAS) server is a storage device that is connected via the Internet and is dedicated to provide file access for computer systems by means of file-sharing network protocols such as SAMBA. The NAS server is capable of easily providing a network data-sharing mechanism with unlimited capacity expansion by means of a distributed architecture. Computer systems with a variety of operating systems can enjoy convenient file access services through the NAS server as long as they are connected to any node of the Internet. Hence, the data access speed of the NAS server has become an important topic of this field.

In general, a data length of an Ethernet packet is typically 1.5K bytes, wherein useful information may occupy a data length of 1-1460 bytes. A hard disk uses “a sector” as its data length unit. In other words, as for the NAS server, the data format of the data received from a network-base is different from the data format of the data being written into the hard disk. Hence, in accordance with the prior art, the received data is reorganized by the operating system of the NAS server so as to perform a data format conversion. As an illustration, please refer to FIG. 1. FIG. 1 shows a simplified block diagram of a conventional network storage system 100 in accordance with the prior art. As shown in FIG. 1, the conventional network storage system 100 comprises: a network processing module 110, a file buffering module of operation system (OS) 120, a driver managing module of OS 130, and a hard disk driver module of OS 140, wherein the network processing module 110 is coupled between a network terminal device 150 and the file buffering module of OS 120, the file buffering module of OS 120 is coupled to the driver managing module of OS 130, the driver managing module of OS 130 is coupled to the hard disk driver module of OS 140, and the hard disk driver module of OS 140 is coupled to a storage device 160. However, the standard process of the file buffering module of OS 120, the driver managing module of OS 130, and hard disk driver module of OS 140 costs a lot of time, and thus the data reading efficiency of the net storage service is very low when using the conventional network storage system and the conventional network storage method. For example, the data reading efficiency of the net storage service is only 14 MB/s.

### SUMMARY OF THE INVENTION

It is therefore one of the objectives of the present invention to provide a network storage system for increasing data reading efficiency of a net storage service and a network storage method for increasing data reading efficiency of the net storage service, so as to solve the above problem.

In accordance with an embodiment of the present invention, a network storage system is disclosed, and the network storage system can be utilized for increasing data reading efficiency of a net storage service. The network storage system comprises: a network processing module, a first file fast transmitting module, and a second file fast transmitting module. The network processing module is coupled to a network terminal device. The first file fast transmitting module is utilized for detecting whether a storage data reading event corresponding to a storage device occurs at the network terminal device via a network-base. The second file fast transmitting module is coupled to the first file fast transmitting module and the network processing module, and utilized for performing a storage data transferring operation procedure for a plurality of times, wherein the second file fast transmitting module comprises: a first data buffer utilized for storing a plurality of first storage data which is received from the storage device and about to be written by the network terminal device in sequence; wherein when the first file fast transmitting module detects that the storage data reading event occurs, the first file fast transmitting module notifies the second file fast transmitting module, and under a condition of without the operation system of the network storage system and during each time of the storage data transferring operation procedure, the second file fast transmitting module transforms a first data format of a first storage data in the first data buffer to a second data format which is compatible with the network processing module, and transmits the second data format of the first storage data in the first data buffer to the network processing module.

In accordance with an embodiment of the present invention, a network storage method is disclosed, and the network storage method can be utilized for increasing data reading efficiency of a net storage service. The network storage method comprises: providing a network processing module, a first file fast transmitting module, and a second file fast transmitting module, wherein the network processing module is coupled to a network terminal device, and the second file fast transmitting module comprises: a first data buffer, for storing a plurality of first storage data which is received from the storage device and about to be written by the network terminal device in sequence; utilizing the first file fast transmitting module to detect whether a storage data reading event corresponding to a storage device occurs at the network terminal device via a network-base; when the first file fast transmitting module detects that the storage data reading event occurs, utilizing the first file fast transmitting module to notify the second file fast transmitting module to perform a storage data transferring operation procedure for a plurality of times; and under a condition of without the operation system of the network storage system and during each time of the storage data transferring operation procedure, utilizing the second file fast transmitting module to transform a first data format of a first storage data in the first data buffer to a second data format which is compatible with the network processing module, and utilizing the second file fast transmitting module to transmit the second data format of the first storage data in the first data buffer to the network processing module.

Briefly summarized, the network storage system for increasing data reading efficiency of a net storage service and the network storage method for increasing data reading efficiency of the net storage service disclosed by the present invention can omit the standard process of the traditional operation system processing files when reading data, and the network storage system and use the modules provided by the present invention to perform file storing functions, and the network storage method of the present invention can use a new file processing procedure in the second file fast transmitting module. In this way, the present invention can shorten the file processing flow in the traditional network storage system, so as to increase data reading efficiency of the net storage service over 250%. For example, if using the conventional network storage system and the conventional network storage method, the data reading efficiency of the net storage service is only 14 MB/s; however, if using the network storage system and the network storage method disclosed by the present invention, the data reading efficiency of the net storage service can be increased to 35 MB/s obviously.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional network storage system in accordance with the prior art.

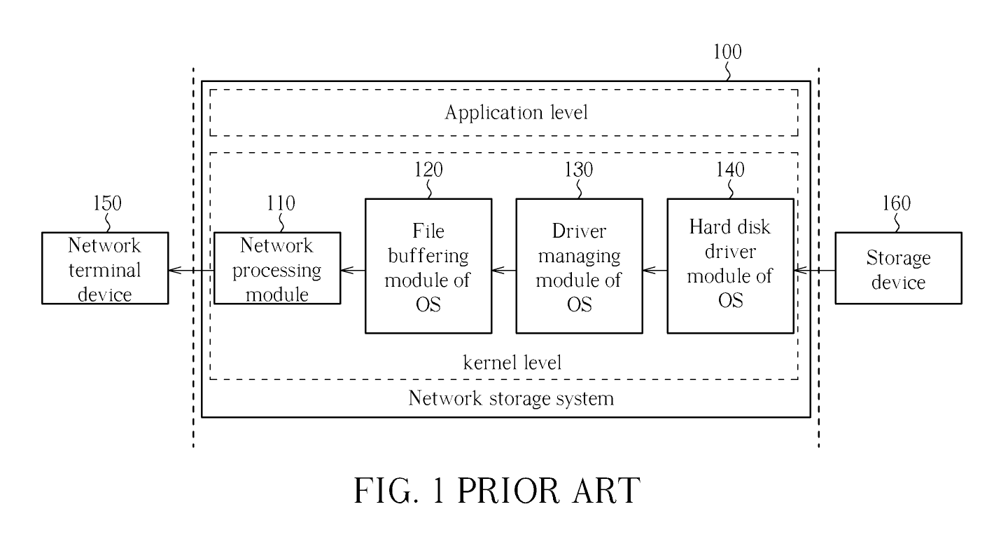

FIG. 2 shows a simplified block diagram of a network storage system for increasing data reading efficiency of a net storage service in accordance with a first embodiment of the present invention.

FIG. 3 is a flowchart showing a network storage method for increasing data reading efficiency of the net storage service in accordance with the operation schemes of the network storage system in the first embodiment of the present invention.

FIG. 4 shows a simplified block diagram of a network storage system for increasing data reading efficiency of a net storage service in accordance with a second embodiment of the present invention.

FIG. 5 is a flowchart showing a network storage method for increasing data reading efficiency of the net storage service in accordance with the operation schemes of the network storage system in the second embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

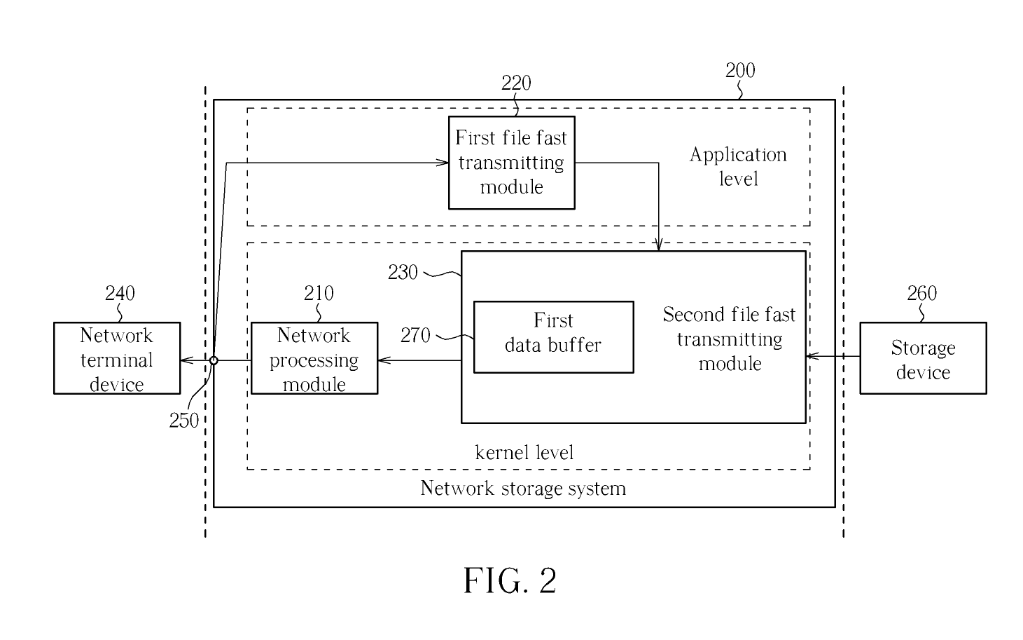

Please refer to FIG. 2. FIG. 2 shows a simplified block diagram of a network storage system 200 for increasing data reading efficiency of a net storage service in accordance with a first embodiment of the present invention, wherein the net storage service is an application program with net storage functions and the network storage system 200 can be a network-attached storage (NAS), such as a SAMBA server. As shown in FIG. 2, the network storage system 200 comprises: a network processing module 210, a first file fast transmitting module 220, and a second file fast transmitting module 230, wherein the first file fast transmitting module 220 operates in an application level of an operation system of the network storage system 200, and the network processing module 210 and the second file fast transmitting module 230 operate in a kernel level of the operation system of the network storage system 200. The network processing module 210 is coupled to a network terminal device 240, wherein the network terminal device 240 can be various electronic devices such as a personal computer, a notebook computer, or a smart phone, etc.

The first file fast transmitting module 220 is utilized for detecting whether a storage data reading event corresponding to a storage device 260 occurs at the network terminal device 240 via a network-base 250, wherein the storage device 260 can be a hard disk. The second file fast transmitting module 230 is coupled to the first file fast transmitting module 220 and the network processing module 210, and utilized for performing a storage data transferring operation procedure for a plurality of times, wherein the second file fast transmitting module 230 comprises a first data buffer 270. The first data buffer 270 is utilized for storing a plurality of first storage data which is received from the storage device 260 and about to be written by the network terminal device 240 in sequence, wherein at least a file is formed by the plurality of first storage data (each first storage data can a size of 1˜65536 byte(s)). When the first file fast transmitting module 220 detects that the storage data reading event occurs, the first file fast transmitting module 220 notifies the second file fast transmitting module 230, and under a condition of without the operation system of the network storage system 200 and during each time of the storage data transferring operation procedure, the second file fast transmitting module 230 transforms a first data format of a first storage data in the first data buffer 270 to a second data format which is compatible with the network processing module 210, and transmits the second data format of the first storage data in the first data buffer 270 to the network processing module 210. Next, the network processing module 210 processes the second data format of the plurality of first storage data in sequence, and transmits the processed first storage data to the network terminal device 240. In the first embodiment of the present invention, the second file fast transmitting module 230 waits a first storage data in the first data buffer 270 to be transformed from the first data format to the second data format, and then transmits the second data format of the first storage data in the first data buffer 270 to the network processing module 210. In addition, please note that the above embodiment is only for an illustrative purpose and is not meant to be a limitation of the present invention.

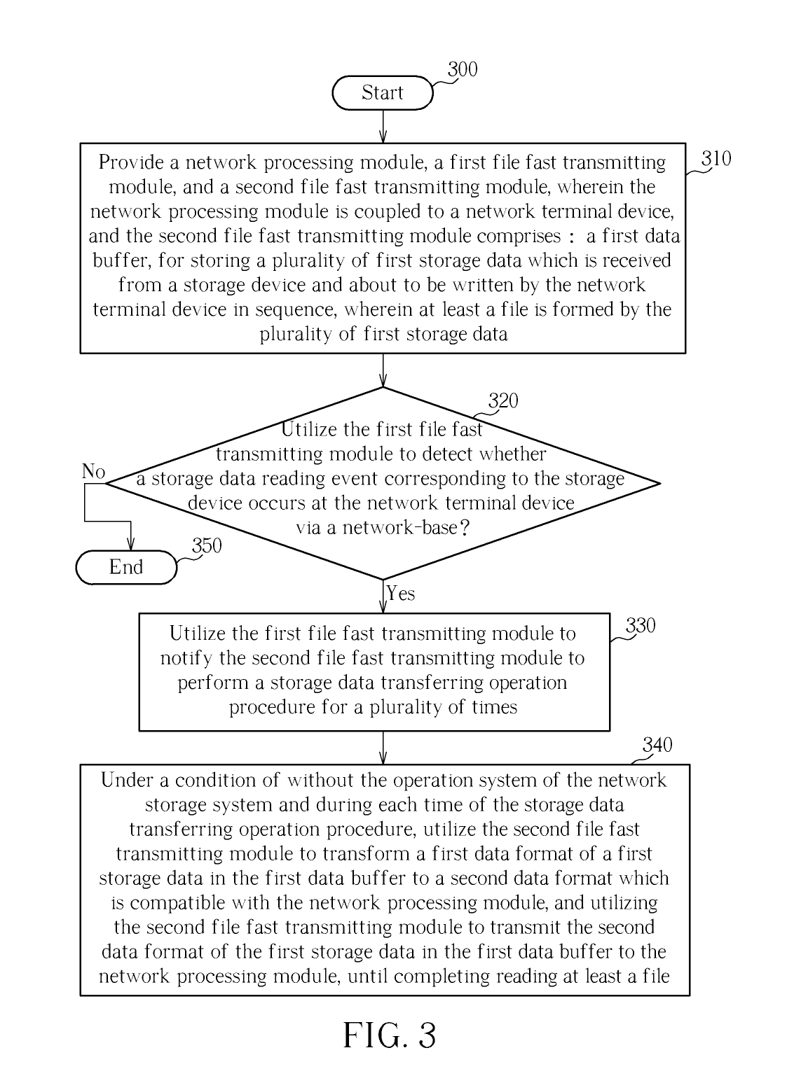

Please refer to FIG. 3. FIG. 3 is a flowchart showing a network storage method for increasing data reading efficiency of the net storage service in accordance with the above operation schemes of the network storage system 200 in the first embodiment of the present invention. Provided that substantially the same result is achieved, the steps of the process flowchart need not be in the exact order shown in FIG. 3 and need not be contiguous, that is, other steps can be intermediate. In addition, please note that the network storage method of the present invention can be realized by a software. In other words, the network storage method disclosed by the present invention can be a software applied to network-attached storage (NAS). The network storage method of the present invention comprises the following steps:

Step 300: Start.

Step 310: Provide a network processing module, a first file fast transmitting module, and a second file fast transmitting module, wherein the network processing module is coupled to a network terminal device, and the second file fast transmitting module comprises: a first data buffer, for storing a plurality of first storage data which is received from the storage device and about to be written by the network terminal device in sequence, wherein at least a file is formed by the plurality of first storage data, and the first file fast transmitting module operates in an application level of an operation system of the network storage system, and the network processing module and the second file fast transmitting module operate in a kernel level of the operation system of the network storage system.

Step 320: Utilize the first file fast transmitting module to detect whether a storage data reading event corresponding to a storage device occurs at the network terminal device via a network-base. If the storage data reading event occurs, go to Step 330; if the storage data reading event does not occur, go to Step 350.

Step 330: Utilize the first file fast transmitting module to notify the second file fast transmitting module to perform a storage data transferring operation procedure for a plurality of times.

Step 340: Under a condition of without the operation system of the network storage system and during each time of the storage data transferring operation procedure, utilize the second file fast transmitting module to transform a first data format of a first storage data in the first data buffer to a second data format which is compatible with the network processing module, and utilize the second file fast transmitting module to transmit the second data format of the first storage data in the first data buffer to the network processing module, until completing reading at least a file.

Step 350: End.

In the flowchart of the first embodiment of the present invention, after the Step 340, the network storage method of the present invention can further comprise: utilizing the network processing module to process the second data format of the plurality of first storage data in sequence; and utilizing the network processing module to transmit the processed first storage data to the network terminal device. Please note that the above embodiment is only for an illustrative purpose and is not meant to be a limitation of the present invention.

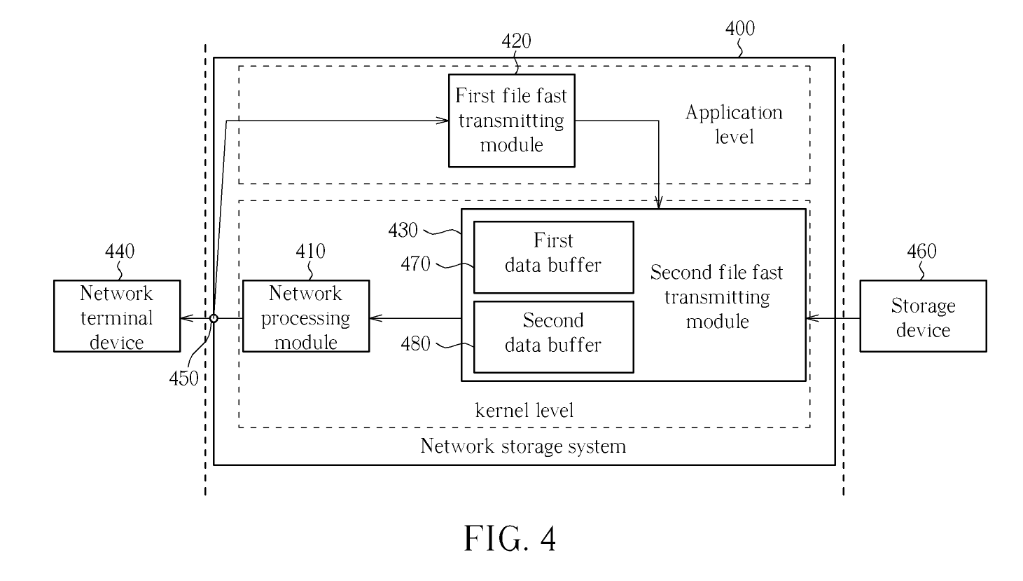

Please refer to FIG. 4. FIG. 4 shows a simplified block diagram of a network storage system 400 for increasing data reading efficiency of a net storage service in accordance with a second embodiment of the present invention, wherein the net storage service is an application program with net storage functions and the network storage system 400 can be a network-attached storage (NAS), such as a SAMBA server. As shown in FIG. 4, the network storage system 400 comprises: a network processing module 410, a first file fast transmitting module 420, and a second file fast transmitting module 430, wherein the first file fast transmitting module 420 operates in an application level of an operation system of the network storage system 400, and the network processing module 410 and the second file fast transmitting module 430 operate in a kernel level of the operation system of the network storage system 400. The network processing module 410 is coupled to a network terminal device 440, wherein the network terminal device 440 can be various electronic devices such as a personal computer, a notebook computer, or a smart phone, etc.

The first file fast transmitting module 420 is utilized for detecting whether a storage data reading event corresponding to a storage device 460 occurs at the network terminal device 440 via a network-base 450, wherein the storage device 460 can be a hard disk. The second file fast transmitting module 430 is coupled to the first file fast transmitting module 420 and the network processing module 410, and utilized for performing a storage data transferring operation procedure for a plurality of times, wherein the second file fast transmitting module 430 comprises a first data buffer 470 and a second data buffer 480. The first data buffer 470 is utilized for storing a plurality of first storage data which is received from the storage device 460 and about to be written by the network terminal device 440 in sequence, and the second data buffer 480 is utilize for storing a plurality of second storage data which is received from the storage device and about to be written by the network terminal device in sequence, wherein at least a file is formed by the plurality of first storage data and the plurality of second storage data (each first storage data or each second storage data can a size of 1˜65536 byte(s)).

When the first file fast transmitting module 420 detects that the storage data reading event occurs, the first file fast transmitting module 420 notifies the second file fast transmitting module 430, and under a condition of without the operation system of the network storage system 400 and during each time of the storage data transferring operation procedure, the second file fast transmitting module 430 transforms a first data format of a first storage data in the first data buffer 470 to a second data format which is compatible with the network processing module 410, and transmits the second data format of the first storage data in the first data buffer 470 to the network processing module 410. Under a condition of without waiting the operation of the first data buffer 470, the second file fast transmitting module 430 can transform a first data format of a second storage data in the second data buffer 480 to a second data format which is compatible with the network processing module 410, and transmits the second data format of the second storage data in the second data buffer 480 to the network processing module 410. Next, the network processing module 410 processes the second data format of the plurality of first storage data and the second data format of the plurality of second storage data in sequence, and transmits the processed first storage data and the processed second storage data to the network terminal device 440.

In the second embodiment of the present invention, the second file fast transmitting module 430 can perform the operation of the second data buffer 480 under a condition of without waiting the operation of the first data buffer 470, and perform the operation of the first data buffer 470 under a condition of without waiting the operation of the second data buffer 480. Thus, the network storage system 400 in accordance with the second embodiment of the present invention can increase data reading efficiency of the net storage service much more.

For example, when the second file fast transmitting module 430 transforms the first data format of a first storage data in the first data buffer 470 to the second data format and transmits the second data format of the first storage data in the first data buffer 470 to the network processing module 410, the second file fast transmitting module 430 will transform the first data format of a second storage data in the second data buffer 480 to the second data format, and the second file fast transmitting module 430 can continue to transform the first data format of a next first storage data in the first data buffer 470 to the second data format during the process of transforming the first data format of the second storage data in the second data buffer 480 to the second data format. After the second storage data in the second data buffer 480 is transformed from the first data format to the second data format, the second file fast transmitting module 430 will transmit the second data format of the second storage data in the second data buffer 480 to the network processing module 410. Next, the second file fast transmitting module 430 can continue to transform the first data format of a next second storage data in the second data buffer 480 to the second data format during the process of transforming the first data format of the next first storage data in the first data buffer 470 to the second data format, and after the next first storage data in the first data buffer 470 is transformed from the first data format to the second data format, the second file fast transmitting module 430 will transmit the second data format of the next first storage data in the first data buffer 470 to the network processing module 410. In addition, please note that the above embodiment is only for an illustrative purpose and is not meant to be a limitation of the present invention.

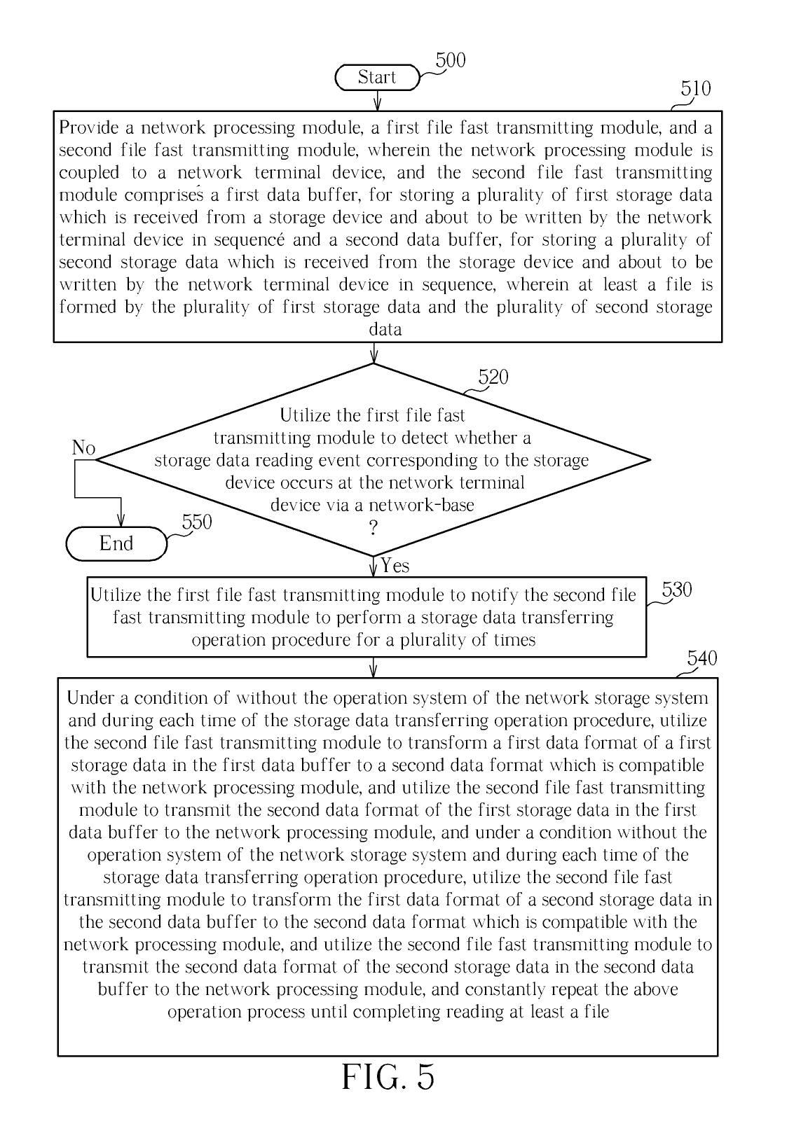

Please refer to FIG. 5. FIG. 5 is a flowchart showing a network storage method for increasing data reading efficiency of the net storage service in accordance with the above operation schemes of the network storage system 400 in the second embodiment of the present invention. Provided that substantially the same result is achieved, the steps of the process flowchart need not be in the exact order shown in FIG. 5 and need not be contiguous, that is, other steps can be intermediate. In addition, please note that the network storage method of the present invention can be realized by a software. In other words, the network storage method disclosed by the present invention can be a software applied to network-attached storage (NAS). The network storage method of the present invention comprises the following steps:

Step 500: Start.

Step 510: Provide a network processing module, a first file fast transmitting module, and a second file fast transmitting module, wherein the network processing module is coupled to a network terminal device, and the second file fast transmitting module comprises: a first data buffer, for storing a plurality of first storage data which is received from a storage device and about to be written by the network terminal device in sequence; and a second data buffer, for storing a plurality of second storage data which is received from the storage device and about to be written by the network terminal device in sequence, wherein at least a file is formed by the plurality of first storage data and the plurality of second storage data.

Step 520: Utilize the first file fast transmitting module to detect whether a storage data reading event corresponding to a storage device occurs at the network terminal device via a network-base. If the storage data reading event occurs, go to Step 530; if the storage data reading event does not occur, go to Step 550.

Step 530: Utilize the first file fast transmitting module to notify the second file fast transmitting module to perform a storage data transferring operation procedure for a plurality of times.

Step 540: Under a condition of without the operation system of the network storage system and during each time of the storage data transferring operation procedure, utilize the second file fast transmitting module to transform a first data format of a first storage data in the first data buffer to a second data format which is compatible with the network processing module, and utilize the second file fast transmitting module to transmit the second data format of the first storage data in the first data buffer to the network processing module, and under a condition of without the operation system of the network storage system and during each time of the storage data transferring operation procedure, utilize the second file fast transmitting module to transform the first data format of a second storage data in the second data buffer to the second data format which is compatible with the network processing module, and utilize the second file fast transmitting module to transmit the second data format of the second storage data in the second data buffer to the network processing module, and constantly repeat the above operation process until completing reading at least a file.

Step 550: End.

In the flowchart of the second embodiment of the present invention, the second file fast transmitting module can perform the operation of the second data buffer under a condition of without waiting the operation of the first data buffer, and perform the operation of the first data buffer under a condition of without waiting the operation of the second data buffer, and constantly repeat the above steps. Thus, the network storage method in accordance with the second embodiment of the present invention can increase data reading efficiency of the net storage service much more.

For example, after the Step 540 in the flowchart of the second embodiment of the present invention, the network storage method of the present invention can further comprise: utilizing the second file fast transmitting module to continue to transform the first data format of a next first storage data in the first data buffer to the second data format during the process of transforming the first data format of the second storage data in the second data buffer to the second data format; after the second storage data in the second data buffer is transformed from the first data format to the second data format, utilizing the second file fast transmitting module to transmit the second data format of the second storage data in the second data buffer to the network processing module; utilizing the second file fast transmitting module to continue to transform the first data format of a next second storage data in the second data buffer to the second data format during the process of transforming the first data format of the next first storage data in the first data buffer to the second data format; and after the next first storage data in the first data buffer is transformed from the first data format to the second data format, utilizing the second file fast transmitting module to transmit the second data format of the next first storage data in the first data buffer to the network processing module.

In addition, in the flowchart of the second embodiment of the present invention, after the Step 540, the network storage method of the present invention can further comprise: utilizing the network processing module to process the second data format of the plurality of first storage data and the second data format of the plurality of second storage data in sequence; and utilizing the network processing module to transmit the processed first storage data and the processed second storage data to the network terminal device. Please note that the above embodiment is only for an illustrative purpose and is not meant to be a limitation of the present invention.

Briefly summarized, the network storage system for increasing data reading efficiency of a net storage service and the network storage method for increasing data reading efficiency of the net storage service disclosed by the present invention can omit the standard process of the traditional operation system processing files when reading data, and the network storage system and use the modules provided by the present invention to perform file storing functions, and the network storage method of the present invention can use a new file processing procedure in the second file fast transmitting module. In this way, the present invention can shorten the file processing flow in the traditional network storage system, so as to increase data reading efficiency of the net storage service over 250%. For example, if using the conventional network storage system and the conventional network storage method, the data reading efficiency of the net storage service is only 14 MB/s; however, if using the network storage system and the network storage method disclosed by the present invention, the data reading efficiency of the net storage service can be increased to 35 MB/s obviously.

Those skilled in the art will readily observe that numerous modifications and alterations of the device and method may be made while retaining the teachings of the invention.

What is claimed is:

1. A network storage system, comprising:
a network processing module, coupled to a network terminal device;
a first file fast transmitting module, for detecting whether a storage data reading event corresponding to a storage device occurs at the network terminal device via a network-base; and
a second file fast transmitting module, coupled to the first file fast transmitting module and the network processing module, for performing a storage data transferring operation procedure for a plurality of times, wherein the second file fast transmitting module comprises: a first data buffer, for storing a plurality of first storage data which is received from the storage device and about to be written by the network terminal device in sequence; wherein when the first file fast transmitting module detects that the storage data reading event occurs, the first file fast transmitting module notifies the second file fast transmitting module, and under a condition of without the operation system of the network storage system and during each time of the storage data transferring operation procedure, the second file fast transmitting module transforms a first data format of a first storage data in the first data buffer to a second data format which is compatible with the network processing module, and transmits the second data format of the first storage data in the first data buffer to the network processing module.

2. The network storage system of claim 1, wherein the network processing module processes the second data format of the plurality of first storage data in sequence, and transmits the processed first storage data to the network terminal device.

3. The network storage system of claim 1, wherein the second file fast transmitting module waits a first storage data in the first data buffer to be transformed from the first data format to the second data format, and then transmits the second data format of the first storage data in the first data buffer to the network processing module.

4. The network storage system of claim 2, wherein at least a file is formed by the plurality of first storage data.

5. The network storage system of claim 1, wherein the second file fast transmitting module further comprises:
a second data buffer, for storing a plurality of second storage data which is received from the storage device and about to be written by the network terminal device in sequence;
wherein when the first file fast transmitting module detects that the storage data reading event occurs, the first file fast transmitting module notifies the second file fast transmitting module, and under a condition of without the operation system of the network storage system and during each time of the storage data transferring operation procedure, the second file fast transmitting module transforms a first data format of a second storage data in the second data buffer to a second data format which is compatible with the network processing module, and transmits the second data format of the second storage data in the second data buffer to the network processing module.

6. The network storage system of claim 5, wherein the second file fast transmitting module continues to transform the first data format of a next first storage data in the first data buffer to the second data format during the process of transforming the first data format of the second storage data in the second data buffer to the second data format, and after the second storage data in the second data buffer is transformed from the first data format to the second data format, the second file fast transmitting module transmits the second data format of the second storage data in the second data buffer to the network processing module.

7. The network storage system of claim 6, wherein the second file fast transmitting module continues to transform the first data format of a next second storage data in the second data buffer to the second data format during the process of transforming the first data format of the next first storage data in the first data buffer to the second data format, and after the next first storage data in the first data buffer is transformed from the first data format to the second data format, the second file fast transmitting module transmits the second data format of the next first storage data in the first data buffer to the network processing module.

8. The network storage system of claim 5, wherein the network processing module processes the second data format of the plurality of second storage data in sequence, and transmits the processed second storage data to the network terminal device.

9. The network storage system of claim 5, wherein at least a file is formed by the plurality of second storage data.

10. The network storage system of claim 1, wherein the first file fast transmitting module operates in an application level of an operation system of the network storage system, and the network processing module and the second file fast transmitting module operate in a kernel level of the operation system of the network storage system.

11. The network storage system of claim 1, being a SAMBA server.

12. The network storage system of claim 1, wherein the storage device is a hard disk, and the network terminal device is a computer or a smart phone.

13. A network storage method, comprising:
providing a network processing module, a first file fast transmitting module, and a second file fast transmitting module, wherein the network processing module is coupled to a network terminal device, and the second file fast transmitting module comprises: a first data buffer, for storing a plurality of first storage data which is received from the storage device and about to be written by the network terminal device in sequence;
utilizing the first file fast transmitting module to detect whether a storage data reading event corresponding to a storage device occurs at the network terminal device via a network-base;
when the first file fast transmitting module detects that the storage data reading event occurs, utilizing the first file fast transmitting module to notify the second file fast transmitting module to perform a storage data transferring operation procedure for a plurality of times; and
under a condition of without the operation system of the network storage system and during each time of the storage data transferring operation procedure, utilizing the second file fast transmitting module to transform a first data format of a first storage data in the first data buffer to a second data format which is compatible with the network processing module, and utilizing the second file fast transmitting module to transmit the second data format of the first storage data in the first data buffer to the network processing module.

14. The network storage method of claim 13, further comprising:
utilizing the network processing module to process the second data format of the plurality of first storage data in sequence; and
utilizing the network processing module to transmit the processed first storage data to the network terminal device.

15. The network storage method of claim 13, wherein the step of utilizing the second file fast transmitting module to transmit the second data format of the first storage data in the first data buffer to the network processing module comprises:
utilizing the second file fast transmitting module to wait a first storage data in the first data buffer to be transformed from the first data format to the second data format, and then utilizing the second file fast transmitting module to transmit the second data format of the first storage data in the first data buffer to the network processing module.

16. The network storage method of claim 13, wherein at least a file is formed by the plurality of first storage data.

17. The network storage method of claim 13, wherein the second file fast transmitting module further comprises:
a second data buffer, for storing a plurality of second storage data which is received from the storage device and about to be written by the network terminal device in sequence;
wherein when the first file fast transmitting module detects that the storage data reading event occurs, the network storage method further comprises:
under a condition of without the operation system of the network storage system and during each time of the storage data transferring operation procedure, utilizing the second file fast transmitting module to transform a first data format of a second storage data in the second data buffer to a second data format which is compatible with the network processing module, and utilizing the second file fast transmitting module to transmit the second data format of the second storage data in the second data buffer to the network processing module.

18. The network storage method of claim 17, further comprising:
utilizing the second file fast transmitting module to continue to transform the first data format of a next first storage data in the first data buffer to the second data format during the process of transforming the first data format of the second storage data in the second data buffer to the second data format; and
after the second storage data in the second data buffer is transformed from the first data format to the second data format, utilizing the second file fast transmitting module to transmit the second data format of the second storage data in the second data buffer to the network processing module.

19. The network storage method of claim 18, further comprising:
utilizing the second file fast transmitting module to continue to transform the first data format of a next second storage data in the second data buffer to the second data format during the process of transforming the first data format of the next first storage data in the first data buffer to the second data format; and
after the next first storage data in the first data buffer is transformed from the first data format to the second data format, utilizing the second file fast transmitting module to transmit the second data format of the next first storage data in the first data buffer to the network processing module.

20. The network storage method of claim 17, further comprising:
utilizing the network processing module to process the second data format of the plurality of second storage data in sequence; and
utilizing the network processing module to transmit the processed second storage data to the network terminal device.

21. The network storage method of claim 17, wherein at least a file is formed by the plurality of second storage data.

22. The network storage method of claim 13, wherein the first file fast transmitting module operates in an application level of an operation system of the network storage system, and the network processing module and the second file fast transmitting module operate in a kernel level of the operation system of the network storage system.

23. The network storage method of claim 13, being applied to a SAMBA server.

24. The network storage method of claim 13, wherein the storage device is a hard disk, and the network terminal device is a computer or a smart phone.
